(19) United States
(12) Patent Application Publication
(10) Pub. No.: US 2005/0007627 A1
(43) Pub. Date: Jan. 13, 2005

(54) Method and apparatus to control network printing and computer-readable recording medium to store computer program therefor

(75) Inventor: Jun-hyung Ha, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/882,243

(22) Filed: Jul. 2, 2004

(30) Foreign Application Priority Data
Jul. 9, 2003 (KR) 2003-46322

(51) Int. Cl. G06F 15/00

(52) U.S. Cl. 358/1.15

(57) ABSTRACT

A method and apparatus to control printing of printers connected with a network and a computer-readable recording medium to store a computer program are provided. The method includes finding and registering identification information that identifies universal plug-and-play printers supporting universal plug-and-play among the printers connected with the network, monitoring the universal plug-and-play printers using the registered identification information, and selectively transmitting printing data to desired universal plug-and-play printers among the universal plug-and-play printers.

### CROSS-REFERENCE TO RELATED APPLICATION

This application claims the priority of Korean Patent Application No. 2003-46322, filed on Jul. 9, 2003 in the Korean Intellectual Property Office, the disclosure of which is incorporated herein by reference.

### BACKGROUND OF THE INVENTION

1. Field of the Invention

The present invention relates to printing technology, more particularly, to a method and apparatus to control a printer to print via a network, and a computer-readable recording medium to store a computer program therefor.

2. Description of the Related Art

An apparatus to control network printing is discussed in Japanese Published Patent Application No. 2000-207157, filed by Canon Inc. This apparatus broadcasts printing data to a plurality of printers. Then, each printer connected with the apparatus via a network receives the printing data, and prints out the printing data.

However, such apparatuses as the one described above merely transmit the same printing data to all the printers connected via the network and cannot transmit different printing data to the printers. In addition, the printing data is transmitted to the printers connected via the network once and cannot be retransmitted to a particular printer when transmission to or a printing operation of the particular printer fails. Moreover, such apparatuses cannot synthetically manage printers connected thereto via a network, cannot detect a state of each printer, and cannot selectively transmit printing data to a particular printer. Further, such apparatuses require a user to manually register identification information of each printer connected thereto via a network, thereby inconveniencing the user.

### SUMMARY OF THE INVENTION

An aspect of the present invention provides a method to control network printing of printers, which are connected via a network, and to support universal plug-and-play (UPnP).

An aspect of the present invention also provides an apparatus to control network printing of printers, which are connected via a network, and to support UPnP.

An aspect of the present invention provides a computer-readable recording medium to store a computer program to control network printing of printers, which are connected via a network, and to support UPnP.

Additional aspects and/or advantages of the invention will be set forth in part in the description which follows and, in part, will be obvious from the description, or may be learned by practice of the invention.

According to an aspect of the present invention, a method to control printing operations of printers connected with a network is provided. The method comprises: determining and registering identification information to identify UPnP printers that support UPnP among the printers connected with the network, and monitoring the UPnP printers using the registered identification information and selectively transmitting printing data to desired UPnP printers among the UPnP printers.

According to another aspect of the present invention, an apparatus to control printing operations of printers connected with a network is provided. The apparatus comprises: an identification information registering unit to determine and to register identification information to identify UPnP printers that support UPnP among the printers connected with the network, and a printer monitoring unit to monitor the UPnP printers using the registered identification information received from the identification information registering unit and to selectively transmit printing data to desired UPnP printers among the UPnP printers.

According to another aspect of the present invention, a computer-readable recording medium to store at least one computer program readable by a computer to perform a method of controlling an apparatus that controls printing operations of printers connected with a network is provided. The method of the computer program comprises: determining and registering identification information to identify UPnP printers that support UPnP among the printers connected with the network, and monitoring the UPnP printers using the registered identification information and selectively transmitting printing data to desired UPnP printers among the UPnP printers.

### BRIEF DESCRIPTION OF THE DRAWINGS

The above and/or other aspects and advantages of the invention will become more apparent, and more readily appreciated from the following description of the embodiments, taken in conjunction with the accompanying drawings of which:

FIG. 1 is a flowchart of a method to control network printing according to an aspect of the present invention;

FIG. 2 is a block diagram to explain the method shown in FIG. 1 according to an aspect of the present invention;

FIG. 3 is a flowchart of operation 10 shown in FIG. 1 according to an aspect of the present invention;

FIG. 4 is a flowchart of operation 12 shown in FIG. 1 according to an aspect of the present invention;

FIG. 5 is a flowchart of operation 12 shown in FIG. 1 according to another aspect of the present invention;

FIG. 6 is a block diagram of an apparatus to control network printing according to an aspect of the present invention;

FIG. 7 is a block diagram of an identification information registering unit shown in FIG. 6 according to an aspect of the present invention;

FIG. 8 is a block diagram of a printer monitoring unit shown in FIG. 6 according to an aspect of the present invention;

FIG. 9 is a block diagram of the printer monitoring unit shown in FIG. 6 according to another aspect of the present invention; and

FIG. 10 is a block diagram of the printer monitoring unit shown in FIG. 6 according to another aspect of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout.

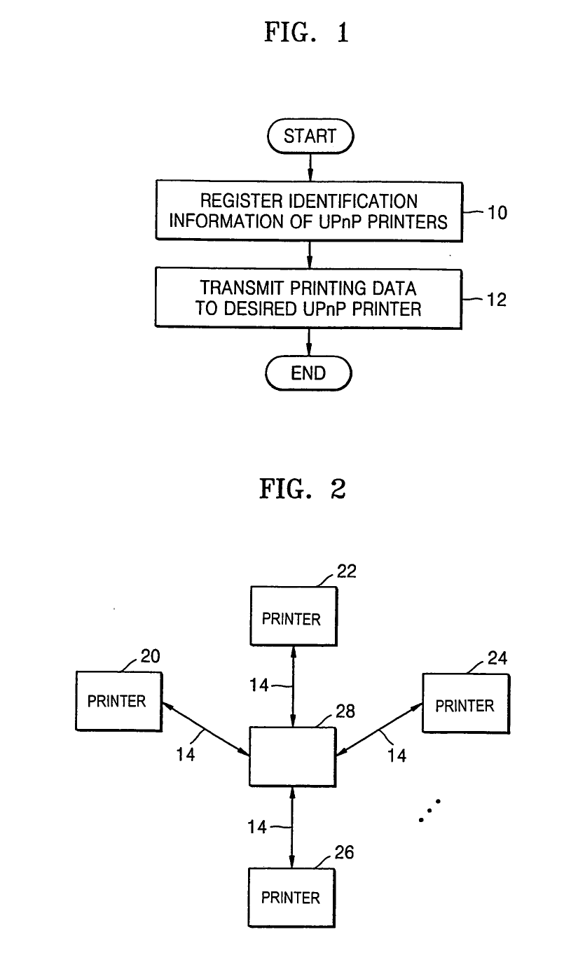

FIG. 1 is a flowchart of a method to control network printing according to an aspect of the present invention. The method includes printing data using printers that support universal plug-and-play (UPnP) in operations 10 and 12. Standards for UPnP are promulgated by the UPnP Forum and generally enable data communication between any of a plurality of devices under the command of a control device on the network and is a protocol independent of operating system, programming language, and physical medium. For printers, the UPnP standard is Printer Device v.1.0 and Printer Basic Service v.1.01, the disclosure of which are incorporated by reference. However, it is understood that other types of network architectures of similar nature, both open and closed, may be used.

FIG. 2 is a block diagram to explain the method shown in FIG. 1 according to an aspect of present invention. Reference numeral 14 denotes a network connection. Reference numerals 20, 22, 24, and 26 denote printers, and reference numeral 28 denotes a network printing control apparatus.

According to an aspect of the present invention, the network 14 shown in FIG. 2 is a home network and/or a local network. While the network 14 is described in terms of a home and/or local network, the present invention can be used in various types of networks including both wired and wireless networks as well as the Internet and an Intranet. The network printing control apparatus 28 is referred to as a control point (CP) and may be a desktop computer, a notebook computer, a personal digital assistant (PDA), and/or other similar devices.

The method to control network printing according to an aspect of the present invention is used to control printing operations of UPnP printers that support UPnP among printers 20, 22, 24, and 26 connected via the network 14. According to an aspect of the present invention, the control of printing operations of UPnP printers is performed by the network printing control apparatus 28.

According to the method, identification information to identify the UPnP printers that support the UPnP among printers 20, 22, 24, and 26 is determined and registered in operation 10. According to an aspect of the present invention, the identification information is set and/or changed by a user or a printer manufacturer.

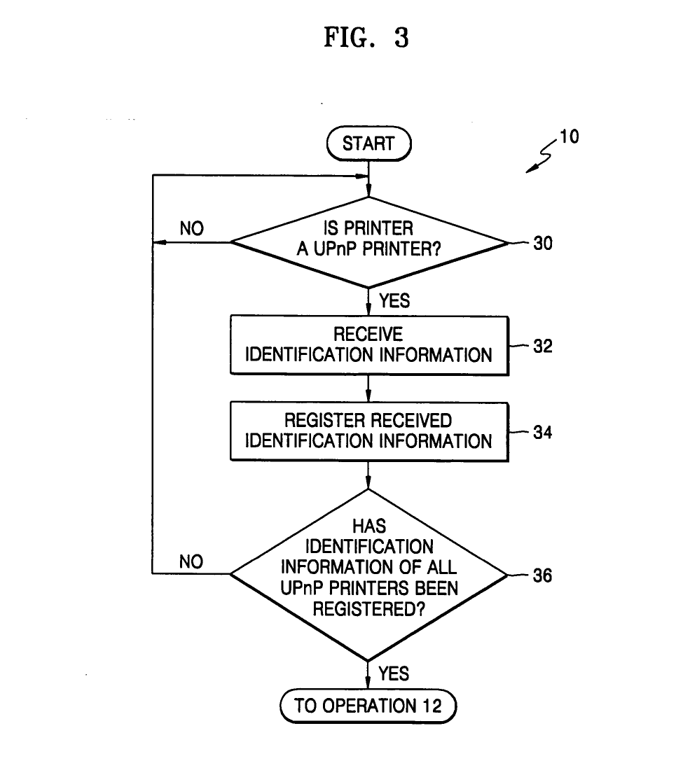

FIG. 3 is a flowchart of operation 10 shown in FIG. 1 according to an aspect of the present invention. Operation 10 includes determining and registering identification information of each of the UPnP printers in operations 30 through 36. Accordingly, it is determined whether a printer 20, 22, 24, or 26 connected with the network 14 is a UPnP printer in operation 30. Upon determining that the printer 20, 22, 24, or 26 is not a UPnP printer, operation 30 is repeated. However, upon determining that the printer is the UPnP printer, identification information is received from the UPnP printer 20, 22, 24, or 26 in operation 32. According to an aspect of the present invention, the identification information from the UPnP printer 20, 22, 24, or 26 is received using a UPnP protocol.

After operation 32, the identification information received from the UPnP printer is registered in operation 34. Subsequently, it is determined whether identification information of all UPnP printers 20, 22, 24, or 26 connected with the network 14 has been registered in operation 36. Upon determining that the identification information of all UPnP printers 20, 22, 24, or 26 connected with the network 14 has been registered, operation 10 shown in FIG. 3 ends, and the operation moves to operation 12 shown in FIG. 1. However, upon determining that the identification information of all UPnP printers 20, 22, 24, or 26 connected with the network 14 has not been registered, the operation moves to operation 30 to register identification information of remaining UPnP printers.

According to an aspect of the present invention, identification information is registered as shown in FIG. 3 using a discovery function unique to UPnP architecture that allows the network printing control apparatus/control point 8 to search for UPnP printers and allows the UPnP printers 20, 22, 24, or 26 to broadcast services of the UPnP printers 20, 22, 24, and 26 when the network printing control apparatus/control point and/or UPnP printers 20, 22, 24, and 26 are connected with the network 14, respectively.

After operation 10, the UPnP printers 20, 22, 24, or 26 are monitored using the registered identification information, and printing data is selectively transmitted to a desired printer 20, 22, 24, or 26 among the UPnP printers 20, 22, 24, or 26 being monitored in operation 12. Thus, the method to control network printing according to an aspect of the present invention, allows printing data having different information to be transmitted to individual UPnP printers 20, 22, 24, or 26, and/or printing data having the same information to be transmitted to all of the UPnP printers 20, 22, 24, or 26. According to an aspect of the present invention, the printing data includes various types of information, such as advertisements, weather, news, etc. For example, in a case where the printing data is an apartment or building management fee, printers 20, 22, 24, and 26 connected via the network 14 are printers installed in households of an apartment or in offices of a building, and the network printing control apparatus 28 is installed in a control room of the apartment or the building.

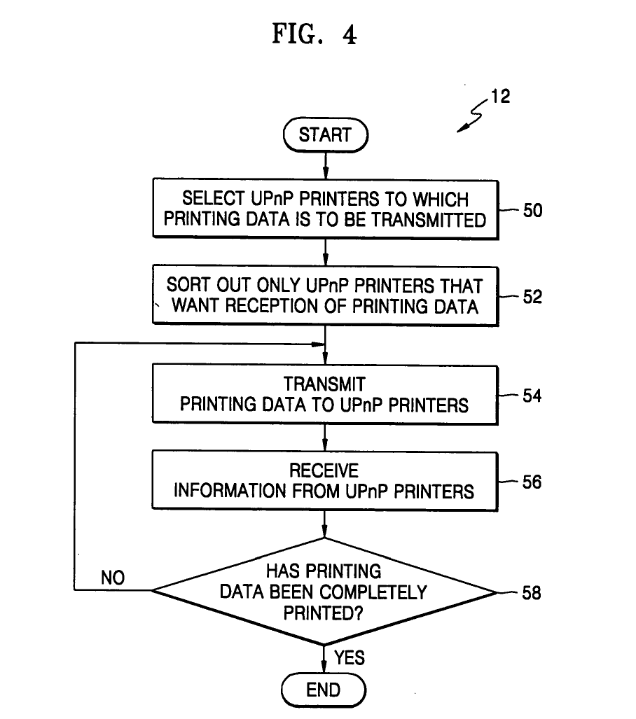

FIG. 4 is a flowchart of operation 12 shown in FIG. 1 according to an aspect of the present invention. Operation 12 includes transmitting the printing data to the desired UPnP printer 20, 22, 24, or 26 in operations 50 through 54, and monitoring whether the printing data is printed normally in operations 56 and 58.

According to an aspect of the present invention, operation 12 shown in FIG. 1 includes operations 50, 52, and 54 shown in FIG. 4. Accordingly, UPnP printers 20, 22, 24, or 26 to which the printing data is to be transmitted are selected in operation 50. After operation 50, only UPnP printers 20, 22, 24, or 26 wanting reception of the printing data are sorted out from the selected UPnP printers 20, 22, 24, or 26 using the registered identification information in operation 52. In other words, when a UPnP printer 20, 22, 24, or 26 reports in advance that the UPnP printer 20, 22, 24, or 26 would not receive the printing data, the printing data is not transmitted to the UPnP printer 20, 22, 24, or 26 even when the UPnP printer 20, 22, 24, or 26 is selected as a printer to which the printing data is to be transmitted. After operation 52, the printing data is transmitted to only the sorted-out UPnP printers 20, 22, 24, or 26 in operation 54.

According to another aspect of the present invention, operation 12 shown in FIG. 1 includes only operations 50 and 54 shown in FIG. 4. Accordingly, UPnP printers to which the printing data is to be transmitted are selected in operation 50. After operation 50, the printing data is transmitted to the selected UPnP printers 20, 22, 24, or 26 in operation 54.

According to another aspect of the present invention, operation 12 shown in FIG. 1 includes operations 50 through 58 shown in FIG. 4. And according to another aspect of the present invention, operation 12 shown in FIG. 1 includes operations 50, 54, 56, and 58 shown in FIG. 4. Accordingly, at least one type of information among information regarding whether the printing data has been completely transmitted and information regarding whether the printing data has been completely printed is received from each UPnP printer 20, 22, 24, or 26 in operation 56. The UPnP printers 20, 22, 24, or 26 transmitting the at least type of information are the UPnP printers 20, 22, 24, or 26 selected in operation 50 when operation 12 shown in FIG. 4 does not include operation 52 and the UPnP printers 20, 22, 24, or 26 sorted in operation 52 when the operation 12 shown in FIG. 4 includes operation 52.

After operation 56, it is determined whether printing has been completed normally based on the information received from the selected or sorted-out UPnP printers 20, 22, 24, or 26 in operation 58. Upon determining that printing has not been completed normally, the operation returns to operation 54 to retransmit the printing data to only a UPnP printer 20, 22, 24, or 26 that did not complete printing normally. However, Upon determining that printing has been completed normally, operation 12 shown in FIG. 4 ends.

For example, assume that the printing data includes information transmitted to each household of an apartment from a control room of the apartment and the network printing control apparatus 28 monitors information shown in Table 1.

TABLE 1

| | | State of | |
|---|---|---|---|
| | Current state of | request | |
| | connection with | reception of | |
| Registered UPnP printers | network | printing data | Others |
| Printer in room 1 on first floor | Online | ◯ | |
| of apartment A | | | |
| Printer in room 2 on first floor | Online | ◯ | |
| of apartment A | | | |
| Printer in room 1 on second | Offline | ◯ | |
| floor of apartment Z | | | |
| Printer in room 2 on second | Online | X | |
| floor of apartment Z | | | |

Referring to Table 1 and FIG. 1, identification information of the printers installed in rooms 1 and 2 on the first floor of apartment A and rooms 1 and 2 on the second floor of the apartment Z is registered in operation 10. As shown in Table 1, the printer installed in room 2 on the second floor of apartment Z has requested to not receive the printing data in advance and the printer in room 1 on the second floor of apartment Z is not currently connected with the network in operation 12.

When the printers installed in rooms 1 and 2 on the first floor of apartment A and rooms 1 and 2 on the second floor of apartment Z are selected as printers to which printing data is to be transmitted in operation 50 shown FIG. 4, because the printer installed in room 2 on the second floor of apartment Z has requested to not receive the printing data, only the printers installed in rooms 1 and 2 on the first floor of apartment A and room 1 on the second floor of apartment Z are sorted out from the selected printers in operation 52. Then, the printing data is transmitted to the sorted-out printers installed in rooms 1 and 2 on the first floor of apartment A and room 1 on the second floor of apartment Z in operation 54.

Accordingly, information is received from the printers installed in rooms 1 and 2 on the first floor of apartment A and room 1 on the second floor of apartment Z in operation 56. Further, assume that the printer installed in room 1 on the first floor of apartment A has completed printing normally, but the printers installed in room 2 on the first floor of apartment A and room 1 on the second floor of apartment Z have not completed printing normally, as shown in Table 2.

TABLE 2

| Sorted-out UPnP printers | Printing result | Error message | Others |
|---|---|---|---|
| Printer in room 1 on first floor | Normal | | |
| of apartment A | | | |
| Printer in room 2 on first floor | Failed | Out of paper | |
| of apartment A | | | |
| Printer in room 1 on second | Failed | Offline | |
| floor of apartment Z | | | |

In this case, the printing data is selectively retransmitted to the printers installed in room 2 on the first floor of apartment A and room 1 on the second floor of apartment Z in operation 54 that have not completed printing normally. According to an aspect of the present invention, results of printing the retransmitted printing data appears as shown in Table 3 below.

TABLE 3

| | Printing result | |
|---|---|---|
| Failed UPnP printers | after retransmission | Others |
| Printer in room 2 on first floor of | Normal | |
| apartment A | | |
| Printer in room 1 on second floor of | Normal | |
| apartment Z | | |

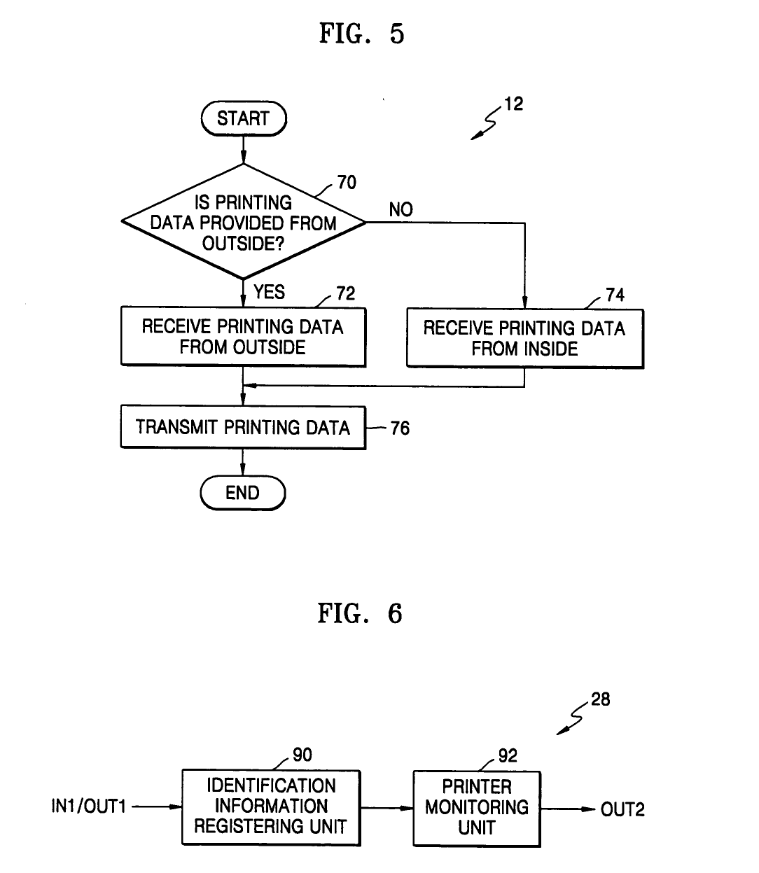

FIG. 5 is a flowchart of operation 12 shown in FIG. 1 according to an aspect of the present invention. Operation 12 includes operations to externally or internally receive printing data and transmit the printing data to the desired printers in operations 70 through 76.

As shown in FIG. 5, it is determined whether the printing data is provided from an outside of the network printing control apparatus 28 in operation 70. Upon determining that the printing data is provided from outside of the network printing control apparatus 28, the printing data is received from the outside in operation 72. As described above, according to an aspect of the present invention, the printing data may be received from a server (not shown) outside the network printing control apparatus 28. In other words, information of printing data may be received from external Internet servers providing weather, news, etc. However, upon determining that the printing data is provided from inside of the network printing control apparatus 28 instead of outside of the apparatus 28, the printing data is received from the inside in operation 74. For example, the printing data may be internally provided in the form of files within the network printing control apparatus 28. After operation 72 or 74, the externally or internally provided printing data is transmitted to the desired UPnP printers 20, 22, 24, or 26 in operation 76.

FIG. 6 is a block diagram of an apparatus to control network printing according to an aspect of the present invention. The apparatus includes an identification information registering unit 90 and a printer monitoring unit 92. The apparatus shown in FIG. 6 performs the method illustrated in FIG. 1, and corresponds to the network printing control apparatus 28 illustrated in FIG. 2.

In operation 10 shown in FIG. 1, the identification information registering unit 90 determines and registers identification information to identify each printer that supports UPnP among the printers 20 through 26 connected with the apparatus via the network 14. For example, the identification information registering unit 90 outputs a printer type inquiry signal to inquire whether each of the printers 20 through 26 is a UPnP printer through an output terminal OUT1. Then, each of the printers 20 through 26 receives the printer type inquiry signal and generates a printer type signal indicative of the printer type. The identification information registering unit 90 determines whether each of the printers 20 through 26 is a UPnP printer based on the printer type signals received from the printers 20 through 26, respectively, through an input terminal IN1, requests identification information from printers determined as being a UPnP printer through the output terminal OUT1, receives the identification information from the UPnP printers through the input terminal IN1, and registers the received identification information.

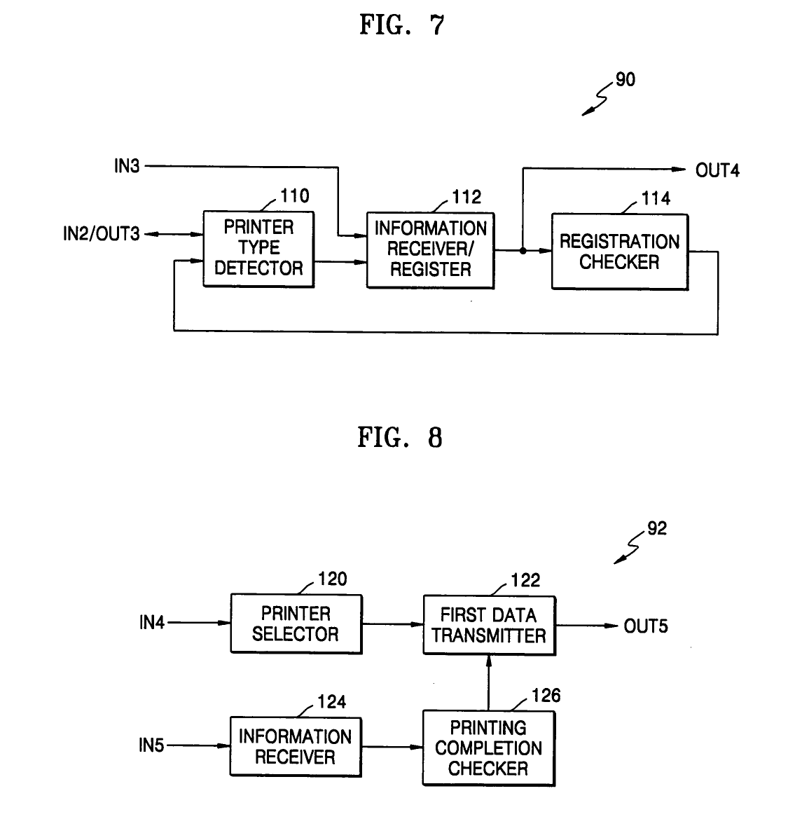

FIG. 7 is a block diagram of the identification information registering unit 90 shown in FIG. 6 according to an aspect of the present invention. The identification information registering unit 90 includes a printer type detector 110, an information receiver/register 112, and a registration checker 114.

The identification information registering unit 90 shown in FIG. 7 performs operation 10 shown in FIG. 3. For example, to perform operation 30, the printer type detector 110 detects whether each of the printers 20 through 26 connected via the network 14 is a UPnP printer in response to a first control signal received from the registration checker 114 and outputs a detection result as a second control signal to the information receiver/register 112. In other words, in an initial state, the printer type detector 110 detects whether the printers 20 through 26 connected via the network 14 are UPnP printers and outputs a detection result as the second control signal. However, in a normal state after the initial state, the printer type detector 110 detects types of printers other than the printers whose type have been detected upon determining that identification information of all of UPnP printers have not been completely registered based on the first control signal. In other words, the printer type detector 110 outputs the printer type inquiry signal requesting printers 20 through 26 whether the printers are UPnP printers through an output terminal OUT3. Then, each of the printers 20 through 26 generates a printer type signal to indicate its type in response to the printer type inquiry signal. Then, the printer type detector 110 detects whether each of the printers 20 through 26 is a UPnP printer based on the printer type signal received from each of the printers 20 through 26 through an input terminal IN2 and outputs a detection result as the second control signal.

In operations 32 and 34, the information receiver/register 112 receives identification information from UPnP printers in response to the second control signal received from the printer type detector 110, registers the received identification information, and outputs the registered identification information to the printer monitoring unit 92 through an output terminal OUT4. In other words, upon determining that a printer is a UPnP printer based on the second control signal, the information receiver/register 112 receives identification information from the UPnP printer through an input terminal IN3 and registers the received identification information.

In operation 36, upon receiving from the information receiver/register 112 a registration completion signal to indicate that identification information registration has been completed, the registration checker 114 checks whether identification information of all UPnP printers connected with the network 14 has been registered and outputs a check result as the first control signal to the printer type detector 110.

In operation 12 shown in FIG. 1, the printer monitoring unit 92 shown in FIG. 6 monitors the UPnP printers 20, 22, 24, or 26 using the registered identification information received from the identification information registering unit 90 and transmits the printing data to the desired printers among the monitored UPnP printers 20, 22, 24, or 26 through an output terminal OUT2.

FIG. 8 is a block diagram of the printer monitoring unit 92 shown in FIG. 6 according to an aspect of the present invention. The printer monitoring unit 92 includes a printer selector 120, a first data transmitter 122, an information receiver 124, and a printing completion checker 126.

The printer monitoring unit 92 shown in FIG. 8 performs operations 50, 54, 56, and 58 shown in FIG. 4. According to an aspect of the present invention, the printer monitoring unit 92 includes only the printer selector 120 and the first data transmitter 122 shown in FIG. 8 to perform operations 50 and 54 shown in FIG. 4. Accordingly, to perform operation 50, the printer selector 120 selects the UPnP printer 20, 22, 24, or 26 to which the printing data is sent. According to an aspect of the present invention, the printer selector 120 is implemented by an operation unit (not shown) that is operated by a user to generate a printing request signal to identify a printer 20, 22, 24, or 26 to print the printing data. The printer selector 120 determines whether a printer 20, 22, 24, or 26 identified by the printing request signal has been registered, based on the identification information received from the identification information registering unit 90 through an input terminal IN4. Upon determining that the printer identified by the printing request signal has been registered, the printer selector 120 outputs the printing request signal to the first data transmitter 122. However, upon determining that the printer 20, 22, 24, or 26 identified by the printing request signal has not been registered, the printer selector 120 does not output the printing request signal to the first data transmitter 122. In operation 54, the first data transmitter 122 recognizes the selected UPnP printer 20, 22, 24, or 26 identified by the printing request signal received from the printer selector 120 and transmits the printing data to the identified UPnP printer 20, 22, 24, or 26 through an output terminal OUT5.

According to another aspect of the present invention, to further perform operations 56 and 58, the printer monitoring unit 92 includes an information receiver 124 and a printing completion checker 126, as shown in FIG. 8. Accordingly, to perform operation 56, the information receiver 124 receives at least one type of information from information regarding whether printing data has been completely transmitted and information regarding whether the printing data has been completely printed from the selected UPnP printer 20, 22, 24, or 26 through an input terminal IN5, and outputs the received information to the printing completion checker 126. To perform operation 58, the printing completion checker 126 checks whether the selected UPnP printer 20, 22, 24, or 26 has normally completed printing based on the information received from the information receiver 124 and outputs a check result as a third control signal to the first data transmitter 122. Then, upon determining that the selected UPnP printer 20, 22, 24, or 26 has not normally completed printing based on the third control signal, the first data transmitter 122 retransmits the printing data only to the UPnP printer 20, 22, 24, or 26 that has not completed printing normally through an output terminal OUT5.

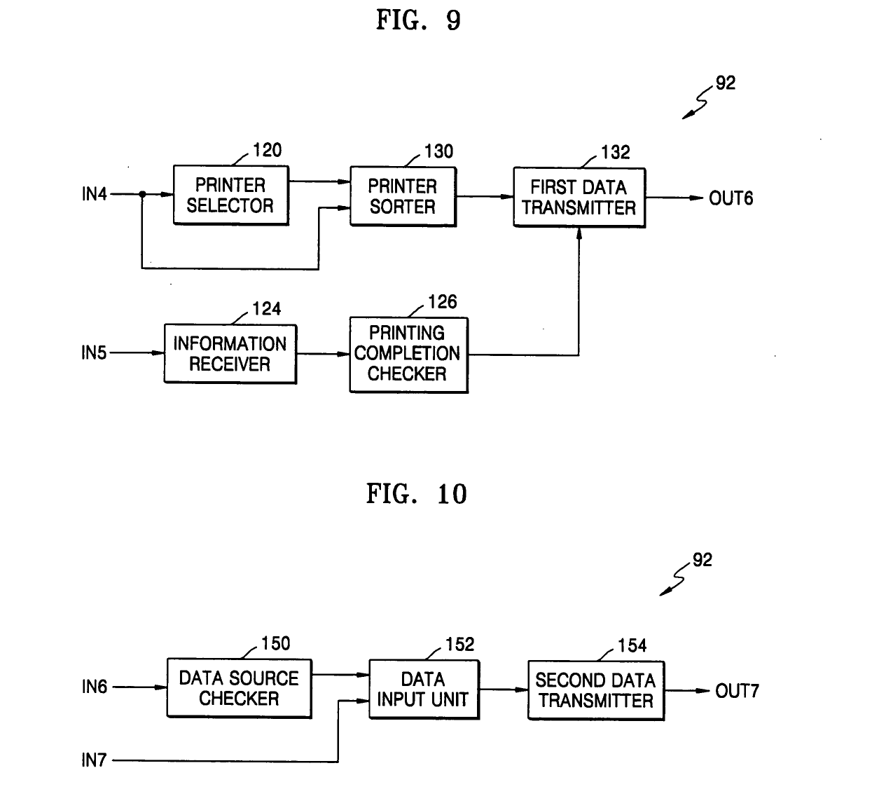

FIG. 9 is a block diagram of the printer monitoring unit 92 shown in FIG. 6 according to an aspect of the present invention. The printer monitoring unit 92 includes a printer selector 120, a printer sorter 130, a first data transmitter 132, an information receiver 124, and a printing completion checker 126.

The printer monitoring unit 92 performs operations 50 through 58 shown in FIG. 4. The printer selector 120, the information receiver 124, and the printing completion checker 126 shown in FIG. 9 respectively perform the same functions as the printer selector 120, the information receiver 124, and the printing completion checker 126 shown in FIG. 8, and thus descriptions thereof will be omitted.

In operation 52, the printer sorter 130 of the printer monitoring unit 92 sorts out only UPnP printers 20, 22, 24, or 26 that request reception of printing data from among UPnP printers selected by the printer selector 120 using registered identification information received from the identification information registering unit 90 through an input terminal IN4 and outputs information to indicate the sorted-out UPnP printers 20, 22, 24, or 26 to the first data transmitter 132. To perform operation 54, the first data transmitter 132 transmits the printing data only to the UPnP printers 20, 22, 24, or 26 sorted out by the printer sorter 130 through an output terminal OUT6.

FIG. 10 is a block diagram of the printer monitoring unit 92 shown in FIG. 6 according to an aspect of the present invention. The printer monitoring unit 92 includes a data source checker 150, a data input unit 152, and a second data transmitter 154. The printer monitoring unit 92 shown in FIG. 10 performs operation 12 shown in FIG. 5.

In operation 70, the data source checker 150 checks whether printing data is provided from outside or inside the apparatus and outputs a check result as a fourth control signal to the data input unit 152. For this operation, the data source checker 150 may receive data source information that indicates whether the printing data is received from outside or inside the apparatus from an operation unit (not shown) operated by a user and may generate the fourth control signal corresponding to the received data source information.

In operation 72 or 74, the data input unit 152 receives the printing data from outside or inside the apparatus through an input terminal IN7 in response to the fourth control signal received from the data source checker 150. For example, upon determining that the printing data is provided from outside the apparatus based on the fourth control signal, the data input unit 152 receives the printing data from outside through the input terminal IN7. However, upon determining based on the fourth control signal that the printing data is provided from inside the apparatus, the data input unit 152 receives the printing data from inside through the input terminal IN7.

In operation 76, the second data transmitter 154 transmits the printing data received from the data input unit 152 to desired UPnP printers 20, 22, 24, or 26 through an output terminal OUT7.

An apparatus to control network printing according to an aspect of the present invention is controlled using a computer program, which is stored in a computer-readable recording medium. For example, the computer program performs operations to determine and register identification information to identify UPnP printers among a plurality of printers, monitor the UPnP printers using the registered identification information, and selectively transmit printing data to a desired printer among the UPnP printers.

A computer program to register the identification information according to an aspect of the present invention performs operations to determine whether a printer connected with a network is a UPnP printer; receives identification information from the UPnP printer upon determining that the printer is a UPnP printer; registers the identification information; determines whether identification information of all UPnP printers connected with the network has been registered; and re-determines whether a printer is a UPnP printer upon determining that the identification information of all UPnP printers has not been registered.

A computer program to transmit the printing data according to an aspect of the present invention comprises: selecting UPnP printers to which the printing data is to be transmitted and transmitting the printing data to selected UPnP printers. According to an aspect of the present invention, the computer program to transmit printing data comprises: sorting out only UPnP printers that request reception of the printing data from among the selected UPnP printers using the registered identification information. Accordingly, the computer program transmits the printing data only to the sorted-out UPnP printers. Further, the computer program to transmit printing data further comprises: receiving at least one type of information among information regarding whether the printing data has been completely transmitted and information regarding whether the printing data has been completely printed from each of the selected or sorted-out UPnP printers, determining whether printing has been normally completed using the received information, and retransmitting the printing data only to UPnP printers determined as not completing printing normally according to a determination result.

A computer program to monitor the UPnP printers according to an aspect of the present invention comprises: determining whether the printing data is provided from outside or inside, receiving the printing data from outside upon determining that the printing data is provided from outside, receiving printing data from inside upon determining that the printing data is provided from inside, and transmitting the printing data received from outside or inside to the desired UPnP printers.

While described in terms of selectively transmitting the printing data to the UPnP printers, it is understood that the network control apparatus can further broadcast the printing data to non-UPnP printers such as using the broadcast method discussed above in relation to Japanese Published Patent Application No. 2000-207157, the disclosure of which is incorporated by reference.

As described above, according to an aspect of the present invention, printing data with the same or different information is transmitted to individual printers connected with a network so that various types of information are easily and quickly transmitted in a home, an office building, public spaces, and/or other networked environments. In addition, because the printing data is to be retransmitted to the printers connected with the network when transmission to a particular printer or a printing operation of the particular printer fails, the printing data is retransmitted to the particular printer. Further, an aspect of the present invention allows the printers connected with the network to be synthetically managed and allows a state of each printer to be detected. Particularly, printers are sorted out, and the printing data is transmitted only to the sorted-out particular printers. Moreover, identification information of the printers connected with the network is automatically registered without additional equipment and a user's input, thereby increasing the user's convenience and decreasing expenses to register printers. In addition, the printing data is not transmitted to UPnP printers that do not request reception of the printing data.

Although a few embodiments of the present invention have been shown and described, it would be appreciated by those skilled in the art that changes may be made in this embodiment without departing from the principles and spirit of the invention, the scope of which is defined in the claims and their equivalents.

1. A method to control printing operations of printers connected with a network, comprising:
determining and registering identification information to identify universal plug-and-play printers that support universal plug-and-play among the printers connected with the network; and
monitoring the universal plug-and-play printers using the registered identification information, and selectively transmitting printing data to desired universal plug-and-play printers among the universal plug-and-play printers.

2. The method according to claim 1, wherein the determining and registering identification information comprises:
determining which of a plurality of the printers connected with the network are universal plug-and-play printers;
receiving the identification information from universal plug-and-play printers upon determining that the printers among the plurality of the printers connected with the network is universal plug-and-play compliant;
registering the identification information received from the universal plug-and-play printers; and
determining whether identification information of all the universal plug-and-play printers connected with the network has been registered, and redetermining which of the plurality of printers connected with the network is a universal plug-and-play printer upon determining that the identification information of all of the universal plug-and-play printers has not been registered.

3. The method according to claim 1, wherein the monitoring the universal plug-and-play printers and selectively transmitting printing data to desired universal plug-and-play printers comprises:
selecting universal plug-and-play printers to which the printing data is to be transmitted; and
transmitting the printing data to the selected universal plug-and-play printers.

4. The method according to claim 3, wherein the monitoring the universal plug-and-play printers and selectively transmitting printing data to desired universal plug-and-play printers further comprises:
sorting out the universal plug-and-play printers that request reception of the printing data from among the universal plug-and-play printers to which the printing data is selectively transmitted using the registered identification information, wherein the transmitting the printing data includes transmitting the printing data only to the sorted-out universal plug-and-play printers such that the universal plug-and-play printers not requesting the printing data do not receive the printing data.

5. The method according to claim 3, wherein the monitoring the universal plug-and-play printers and selectively transmitting printing data to desired universal plug-and-play printers further comprises:
receiving at least one type of information among information regarding whether the printing data has been completely transmitted and information regarding whether the printing data has been completely printed from each of the selected universal plug-and-play printers; and
determining whether the printing data has been completely printed using the received information, and transmitting the printing data to the selected universal plug-and-play printers upon determining that the printing data has not been completely printed, and
the transmitting the printing data to the selected universal plug-and-play printers upon determining includes transmitting the printing data only to the universal plug-and-play printers in which the printing data have not been completely printed.

6. The method according to claim 1, wherein the printing data of the individual universal plug-and-play printers includes different information.

7. The method according to claim 1, wherein the monitoring the universal plug-and-play printers and selectively transmitting printing data to desired universal plug-and-play printers further comprises:
determining whether the printing data is provided from outside and/or inside an apparatus performing the method;
receiving the printing data from outside the network upon determining that the printing data is provided from outside the apparatus performing the method;
receiving the printing data from inside the network upon determining that the printing data is provided from inside the apparatus performing the method; and
transmitting the printing data received from outside and/or inside the apparatus performing the method to the desired universal plug-and-play printers.

8. An apparatus to control printing operations of printers connected with a network, comprising:
an identification information registering unit to determine and register identification information to identify universal plug-and-play printers that support universal plug-and-play among the printers connected with the network; and
a printer monitoring unit to monitor the universal plug-and-play printers using the registered identification information received from the identification information registering unit and selectively transmit printing data to desired universal plug-and-play printers among the universal plug-and-play printers.

9. The apparatus according to claim 8, wherein the identification information registering unit comprises:
a printer type detector to detect whether each printer connected with the network is the universal plug-and-play printer in response to a first control signal and to output a detection result as a second control signal;
an information receiver/register to receive, for each universal plug-and-play printer, the identification information from the universal plug-and-play printer in response to the second control signal and to register the received identification information; and
a registration checker to check whether identification information of all the universal plug-and-play printers connected with the network has been registered and to output a check result as the first control signal.

10. The apparatus according to claim 8, wherein the printer monitoring unit comprises:
a printer selector to select the universal plug-and-play printers to which the printing data is to be transmitted; and
a first data transmitter to transmit the printing data to the selected universal plug-and-play printers and to not transmit the printing data to non-selected ones of the universal plug-and-play printers.

11. The apparatus according to claim 10, wherein the printer monitoring unit further comprises:
a printer sorter to sort out only universal plug-and-play printers that request reception of the printing data from among the selected universal plug-and-play printers using the registered identification information, wherein the first data transmitter transmits the printing data only to the sorted-out universal plug-and-play printers.

12. The apparatus according to claim 10, wherein the printer monitoring unit further comprises:
an information receiver to receive at least one type of information among information regarding whether the printing data has been completely transmitted and information regarding whether the printing data has been completely printed from each of the selected universal plug-and-play printers; and
a printing completion checker to check whether the printing data has been completely printed using the information received from the information receiver and to output a check result as a third control signal, and
the first data transmitter to transmit the printing data only to universal plug-and-play printers in which the printing data has not been completely printed in response to the third control signal.

13. The apparatus according to claim 8, wherein the printer monitoring unit comprises:
a data source checker to identify whether the printing data is provided from one of outside and inside the apparatus and to output a check result as a fourth control signal;
a data input unit to receive the printing data from corresponding one of the outside and inside the apparatus in response to the fourth control signal; and
a second data transmitter to transmit the printing data received from the data input unit to the desired universal plug-and-play printers.

14. A computer-readable recording medium to store at least one computer program for a method to control an apparatus to control printing operations of printers connected with a network, the method comprising:
determining and registering identification information to identify universal plug-and-play printers that support universal plug-and-play among the printers connected with the network; and
monitoring the universal plug-and-play printers using the registered identification information and selectively transmitting printing data to desired universal plug-and-play printers among the universal plug-and-play printers.

15. The computer-readable recording medium according to claim 14, wherein the determining and registering identification information that identifies universal plug-and-play printers comprises:
determining which of a plurality of the printers connected with the network are universal plug-and-play printers;
receiving the identification information from the universal plug-and-play printers upon determining that the printers among the plurality of the printers connected with the network is universal plug-and-play compliant;
registering the identification information received from the universal plug-and-play printers; and determining whether identification information of all the universal plug-and-play printers connected with the network has been registered, and redetermining which of the plurality of printers connected with the network is a universal plug-and-play printer upon determining that the identification information of all of the universal plug-and-play printers has not been registered.

16. The computer-readable recording medium according to claim 14, wherein the monitoring the universal plug-and-play printers and selectively transmitting printing data to desired universal plug-and-play printers comprises:
selecting the universal plug-and-play printers to which the printing data is to be transmitted; and
transmitting the printing data to the selected universal plug-and-play printers.

17. The computer-readable recording medium according to claim 16, wherein the monitoring the universal plug-and-play printers and selectively transmitting printing data to desired universal plug-and-play printers further comprises:
sorting out only the universal plug-and-play printers that request reception of the printing data from among the universal plug-and-play printers to which the printing data is selectively transmitted using the registered identification information, wherein transmitting the printing data includes transmitting the printing data only to the sorted-out universal plug-and-play printers such that non-selected universal plug-and-play printers do not receive the printing data.

18. The computer-readable recording medium according to claim 16, wherein the monitoring the universal plug-and-play printers and selectively transmitting printing data to desired universal plug-and-play printers further comprises:
receiving at least one type of information among information regarding whether the printing data has been completely transmitted and information regarding whether the printing data has been completely printed from each of the selected universal plug-and-play printers; and
determining whether the printing data has been completely printed using the received information, and transmitting the printing data to the selected universal plug-and-play printers upon determining that the printing data has not been completely printed, and
the transmitting the printing data to the selected universal plug-and-play printers includes transmitting the printing data only to universal plug-and-play printers in which the print data has not been completely printed.

19. The computer-readable recording medium according to claim 14, wherein the monitoring the universal plug-and-play printers and selectively transmitting printing data to desired universal plug-and-play printers comprises:
determining whether the printing data is provided from one of outside and inside the apparatus;
receiving the printing data from outside the network upon determining that the printing data is provided from outside the apparatus;
receiving the printing data from inside the network upon determining that the printing data is provided from inside the apparatus; and
transmitting the printing data received from outside and/or inside the apparatus to the desired universal plug-and-play printers.

20. The method according to claim 1, wherein the identification information of the printers is set by a user.

21. The method according to claim 1, wherein the identification information is registered when the universal plug-and-play printers are connected with the network.

22. The apparatus according to claim 8, wherein the identification information registering unit registers the identification information when the universal plug-and-play printers are connected with the network.

23. The apparatus according to claim 8, wherein the apparatus is connected with the network having the printers.

24. The apparatus according to claim 23, wherein the identification information registering unit registers the identification information when the apparatus to control printing operations of printers is connected with the network.

25. The method according to claim 1, wherein the printing data comprises different information that is selectively transmitted to the corresponding universal plug-and-play printers.

26. The method according to claim 1, wherein the printing data has the same information that is transmitted to the corresponding universal plug-and-play printers.

27. The method according to claim 3, further comprising:
transmitting data from each universal plug-and-play printer to indicate whether the printing data is to be transmitted.

28. The method according to claim 27, wherein the printing data is transmitted to the universal plug-and-play printers based on the transmitted data from each universal plug-and-play printer.

29. A method to control printing operations of printers connected with a network, comprising:
registering identification information of each printer among the printers; and
controlling each printer based on the registered identification information, wherein printing data is selectively transmitted to a desired printer among the printers.

30. The method according to claim 29, wherein the identification information of the printers is changed by a user.

31. The method according to claim 29, wherein the identification information is registered when each printer is connected with the network.

32. The method according to claim 31, wherein the identification information is registered using a discovery function of a plug-and-play architecture.

33. The method according to claim 29, wherein the printers are monitored based on the registered identification information.

34. The method according to claim 29, wherein the printing data is transmitted to all the printers.

35. An apparatus to control printing operations of printers connected with a network, comprising:
a storage unit to store identification information to identify printers that support a predetermined network protocol among the printers connected with the network; and
a controller to control the supported printers based on the registered identification information.

36. The apparatus according to claim 35, wherein printing data is selectively transmitted to desired printers among the supported printers.
